(19) United States
(12) Patent Application Publication
(10) Pub. No.: US 2010/0170961 A1
(43) Pub. Date: Jul. 8, 2010

(54) Uniform-Pressure Supply Line System for Varying Elevations and Associated Methods

(75) Inventor: Edmund A. Sinda, Bradenton, FL (US)

Correspondence Address: JACQUELINE E. HARTT, PH. D.;LOWNDES DROSDICK DOSTER KANTOR & REED, P.A., P.O. BOX 2809, ORLANDO, FL, 32802-2809, US

(73) Assignee: DEVELOPMENTAL TECHNOLOGIES, LLC, Bradenton, FL (US)

(21) Appl. No.: 12/652,371

(22) Filed: Jan. 5, 2010

Related U.S. Application Data
(60) Provisional application No. 61/142,447, filed on Jan. 5, 2009.

(51) Int. Cl. B05B 1/14; G05D 7/00; B05B 12/00

(52) U.S. Cl. 239/126; 239/556

(57) ABSTRACT

A system for providing fluid at a uniform pressure throughout varying elevations includes multiple channels or a chambered supply line. The feed into the supply line is maintained at a higher pressure to overcome increasing elevations. The return or open line is run with or next to the feed line. A connection chamber connects the two lines, and the connection to the return line is made by a set minimum-pressure valve, which maintains a desired pressure in the connection chamber by closing upon minimum pressure and opening to relieve higher-than-desired pressure. This system can be used for irrigation, fertilization, pesticide delivery, or any situation in which a consistent pressure is desired at an exit point, such as with membrane or drip tubing-type systems. Membranes can be used as the connection chamber itself.

### CROSS-REFERENCE TO RELATED APPLICATION

This application claims priority to provisional application Ser. No. 61/142,447, filed Jan. 5, 2009.

### BACKGROUND OF THE INVENTION

1. Field of the Invention

The system generally relates to systems and methods for providing a fluid across an area having varying elevations wherein a maximum predetermined pressure is desired.

2. Background

In certain applications, the need to convey a fluid across changing elevation is required. With changing elevations come changes in head pressure. In a high-pressure system, this does not create any issues. However, if the system is required to have an outlet with low pressure at different elevations, the system would require the use of pressure-segregating tanks. These tanks must be installed at every elevation where the threshold pressure is exceeded. If only two dimensional, this is not a complex issue, but with a three-dimensional plot of land changes in elevation (the Y plane) across both the profile (X plane) and the depth (Z plane) must be considered. Many of these pressure-regulating tanks may be required along the way.

As most fields are not flat in either direction, systems that require consistent or low pressures can complex. One alternative is to grade the land to achieve relatively close elevations. Not only is this work time and labor consuming, it also only removes one level of variability when it can be done properly. Another result of leveling the land is that often the most desirable planting soil is stripped away from high spots. In addition, even small changes in elevation can result in large changes in head pressure. A change in 2 feet of elevation approaches 1 psi in pressure change.

One area in which pressure changes greatly affect performance is with irrigation systems. Currently only high-pressure irrigation systems can easily work with rolling elevations. These high-pressure systems tend to also use high volumes of water. Spray nozzles and standard drip tubing may be able to overcome elevation changes by using high-pressure flows, but both have efficiency issues related to their operation and irrigation rates related to plant water consumption rates.

Evaporation causes great efficiency loss for spray nozzles. Once water is sprayed, in excess of 50% can be lost to evaporation in dry and hot climates. With surface drip tubes, this efficiency loss is decreased; however, evaporation from the terrain surface remains, and breezes or wind can greatly increase the evaporation rate. While both of these types of systems are easily installed, performance in terms of water conservation has brought developments in other types of irrigation practice.

Newly developed systems use porous membranes that allow water to sweat or be pulled by the surrounding soil and plants into the ground. These surface and subsurface tubes or membranes increase efficiency as evaporation is greatly reduced, and the rate at which water is applied is slow and gradual, which matches more closely the absorption rates of most plants. But these membrane-type systems can be limited in situations in which low pressures are required to gain even more jumps in operational efficiency. While low pressures are achievable in controlled settings such as greenhouses, maintaining these low pressures over more practical applications such as the rolling elevations of farmland has been extremely difficult, if not impossible.

One common approach to solving pressure changes in elevations when low-pressure feeds are needed is to install pressure regulating tanks. While effective in reducing pressure, these tanks have a specific elevation range over which they can perform. Once that elevation is approached, an additional tank is required, and most often separate supply lines must be provided to that tank to ensure sufficient supply pressure is provided. This greatly adds to the complexity of the system in addition to the cost and labor required to install and maintain the system.

Even in high-pressure system installations, changes in elevation result in a variation in the pressure within the system, often resulting in system performance variations. For example, a drip tube system will have a higher pressure and emit more water at the bottom of a hill than at the top of the hill. This is a simple dictate of physics, that for every one-foot change in elevation, there is a 0.433 change in psi. As a line runs downhill, the pressure increases. As it runs uphill, the pressure decreases.

As fresh water becomes less available and more valuable with time, the need for irrigation systems to provide water and nutrients closer to the absorption rates of plant root systems will continue to increase. Recent developments in low pressure membrane technology have even heightened this need, while low-pressure drip systems and fertilizer feed systems reinforce the current demand.

### SUMMARY OF THE INVENTION

The present invention is directed to a system and method for maintaining a low or set pressure feed of a liquid throughout a network where changes in elevation vary the pressure within the liquid and feed system. The system comprises a series of components that act together to achieve the maintenance of a set pressure below an infeed pressure.

The system comprises a pressurized infeed line adapted for reducing the pressure within a connection chamber or area. While flow is maintained, the pressure is reduced, and excess pressure is vented off through a pressure relief valve into a discharge or return line.

The present invention enables the collection or recycling of unutilized liquid. In irrigation practices the application of fertilizers is often done in excess, with misapplied fertilizer never being consumed by the target plant life. The present system substantially prevents fertilizer runoff and waste. Liquid and fertilizer may be collected and recycled until being absorbed by the target plant life, thereby reducing pollution, waste, and expense.

The system can provide a set pressure supply to any type of system, including, but not intended to be limited to, porous membranes, drip tubes, and emitter heads, in spite of changing elevations.

The features that characterize the invention, both as to organization and method of operation, together with further objects and advantages thereof, will be better understood from the following description used in conjunction with the accompanying drawings. It is to be expressly understood that the drawings are for purpose of illustration and description and are not intended as a definition of the limits of the invention. These and other objects obtained, and advantages offered, by the present invention will become more fully apparent as the description that now follows is read in conjunction with the accompanying drawing.

### BRIEF DESCRIPTION OF THE DRAWING

FIG. 1 illustrates an exemplary assembly of a uniform pressure supply line for varying elevations. Dark arrows indicate direction of fluid flow.

FIG. 2 is a condensed assembly drawing for a system for use with membranes. Dark arrows indicate fluid flow.

FIG. 3 illustrates an elevation change that can cause an increase in pressure.

FIG. 4 illustrates an elevation change that can cause increases and decreases in pressure along the line.

### DETAILED DESCRIPTION OF THE PREFERRED EMBODIMENTS

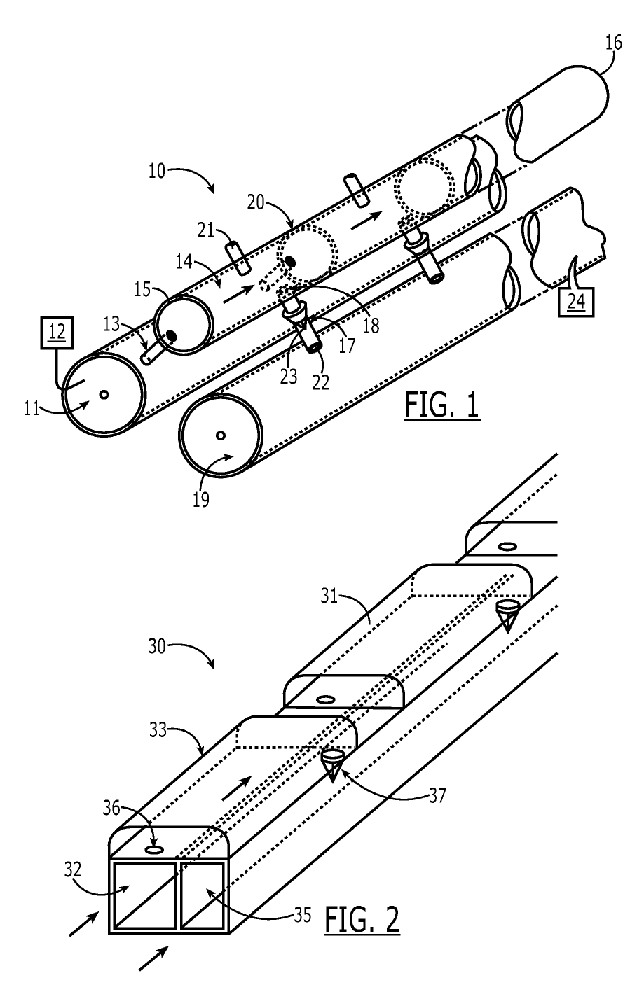

A description of the embodiments of the present invention will now be presented with references to FIGS. 1-4.

As used herein, the word “line” refers to supply and discharge lines for providing fluids, for example, water and/or nutrients when referring to irrigation, but can also encompass other fluids for other applications. As will be appreciated by one skilled in the art, such lines may not be cylindrical, and may be of any shape.

A system and method of supplying fluids across varying elevations is provided that maintains a point of discharge at a desired pressure. While not intended to be a limitation of the invention, this point of discharge is capable of being at low pressure even down to fractional pounds per square inch (psi) across elevation changes of many feet. While the design of the system does provide a substantially constant pressure that is “below” the infeed pressure, the actual pressure differential is a function of the infeed pressure and the changes in elevation. The chamber flow rate should also be a fractional flow rate of the infeed flow rate. All the chambers flow rates should sum up to no more than the infeed flow rate, as a basic dictate of physics.

In a first embodiment 10 (FIG. 1), the system comprises a plurality of components, including an infeed line 11 into which fluid flows from a pressurized source 12. This fluid should be at a pressure that is capable of overcoming a rise in elevation that serves to reduce the pressure of the fluid by 0.433 psi per foot of inclination. The second factor the pressure of the infeed fluid flow must overcome is that of frictional pressure loss through the tubing, which is a function of the line material.

The fluid flows from the infeed line 11 to an inlet 13 connecting the infeed line 11 to a connection chamber 14. The inlet 13, which can comprise a connecting line 13, is smaller than the infeed line 11 to reduce the flow rate so that subsequent connection chambers can all be connected in series along the infeed line 11.

Although the connection chamber 14 is illustrated as being cylindrical, this is not intended as a limitation on the invention, as one skilled in the art will understand this chamber can be of any shape and size. This chamber 14 is sealed on opposed ends 15,20, and can be connected with other, separate chambers in series lengthwise having interior chambers isolated from each other. Alternatively, these chambers could be independent of one another. The only inflow of fluid into the chamber 14 is through the inlet 13 from the feed line 11. While only one inlet 13 is required, multiple inlet lines can serve the same purpose as one line.

Fluid is maintained in the connection chamber 14. The pressure in this chamber 14 is regulated by a pressure-regulating valve 17 located adjacent an outlet 18 of the connection chamber 14. One skilled in the art will understand that the pressure-regulating valve 17 can be positioned substantially anywhere between the connection chamber 14 and a discharge line 19. The actual position shown in FIG. 1 is for illustrative purposes only. The pressure-regulating valve 17 comprises a pressure relief valve with a specified “hold back” pressure. Such valves are commercially available down to fractional psi settings. While not intended to be a limitation of the design, in FIG. 1 the connection chamber 14 is shown as having the end 20 formed as a cylindrical seal, which could be made as a simple weld or pinch, as is obvious to one skilled in the art. The purpose of this seal 20 is to prevent fluid from flowing throughout the other chambers positioned longitudinally in series with the connection chamber 14.

The system 10 further comprises an outlet line 21 for extracting the controlled pressure fluid. This outlet line 21 can be connected to any type of dispersing equipment such as drip tubing, drip heads, membranes, sprayers, etc. Another embodiment includes covering part of or the entire discharge chamber with a porous material, allowing the fluid to be transmitted to the surroundings. Multiple outlet lines from a single connection chamber can comprise another embodiment.

The system 10 additionally comprises a connecting line 22 that connects a discharge 23 of the pressure-regulating valve to the discharge line 19. When the elevation decreases, the discharge line 19 can operate at a free-flow state. If there are positive and negative changes in elevation, a suction pump 24 can be added to ensure proper operation of the pressure regulating valve 17, and to ensure that the pressure in the discharge line 19 remain below that in the feed line 11.

In an embodiment 30, the feed supply line, discharge line, and connection chamber can share one structure (FIG. 2). Although not intended as a limitation on the invention, this structure comprises a porous membrane 31 positioned in covering relation to the connection chamber 33. The membrane 31 itself then becomes the permeable discharge line. The fluid (decreased and constant pressure) is then capable of flowing through the porous membrane 31. While it is not required that the membrane 31 be formed with the infeed 32 and discharge 35 lines, one skilled in the art could appreciate that any of the individual components could have its own structure and be connected via tubing or lines to the other components; the resulting function would be the same. In this embodiment 30, the membrane 31 is illustrated as comprising the connection chamber, but could have comprised a third sealed line instead of a membrane.

The use of a connection chamber 33 with a feed line 34 and a discharge line 35 is what enables efficient operation of the system 30. One skilled in the art will also see that a progressive hole size along the feed line with calibrated inlet and outlet diameters would also provide a steady and constant pressure for a given flow rate, pressure, and velocity. This embodiment 30 should preferably be engineered for specific applications but would allow the design to operate without the pressure-regulating valve. In the simplest form, the pressure-regulating valve can comprise a simple pressure-relief valve, such as a “duck bill” valve.

### Example 1

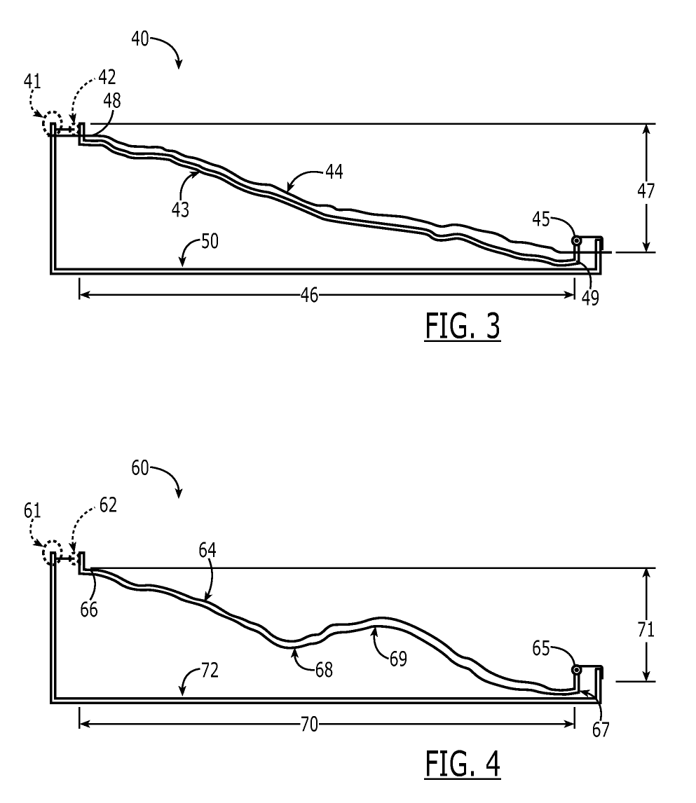

An exemplary downhill application of the system 40 (FIG. 3) illustrates an application to an irrigation or fertilization system. A reservoir tank 41 is used as a means of maintaining a supply of water and/or fertilizer. This reservoir tank could be replaced by a fluid supply line, for example.

In this example, water is pumped via a fluid pump 42 (or gravity fed if the pump is to be omitted) into the feed supply line 43. While not intended as a limitation, the system 40 is shown to be buried as a subsurface line beneath the ground surface 44, following the contour of the land. One skilled in the art will also recognize that this system 40 can also be used as a surface or elevated system.

In a particular embodiment, an additional fluid pump 45 can be added to return the fluid to the storage tank 41, which can be placed anywhere within the system 40. In this application, not intended to be limiting, the system 40 comprises a recirculation system. One of the benefits of a recirculation system is that expensive additives can be used with minimal waste, runoff, and percolation. In standard irrigation practice today, runoff and percolation are major concerns, as fertilizers and salts are contaminating soils, lakes, rivers, and streams. A result of this contamination is fish kills, reduced crop yields, and the destruction of natural ecological systems. Low-pressure supply of the fresh water and fertilizers can significantly reduce runoff, percolation, and fertilizer contamination of the surrounding environment.

When considering prime farmland, a slope of 8 degrees is considered to be maximum. In this example, if the length of application 46 is 500 feet, the elevation change 47 would be 40 feet. Without the use of the present invention for maintaining low pressure along the length of the line, the pressure would increase approximately 17 psi along the span from the elevation start 48 to the elevation end 49, greatly affecting the discharge of irrigation water and/or fertilizer. A second advantage of the present system 40 is that fresh water is conserved, since low-pressure discharge can be applied at much slower rates, less water is used, and water is dispersed at rates closer to the absorption rates of plant life.

The frictional pressure loss at the end of the run in this example can be calculated by knowing the type of material from which the feed supply line is constructed and the length of the line run. Assuming an infeed flow rate of 32 gallons per minute, a velocity of 5 feet per second, a run length of 500 feet, a 1.5-in.-diameter line made from PVC Schedule 40, it can be estimated that the pressure loss due to friction is between 12 and 20 psi. If the 20 psi frictional loss is used, and the 17 psi gain from the change in elevation is added (calculated above), the infeed supply line will have a net 3 psi loss along the run.

If the run were uphill instead of downhill, the net pressure loss would be 37 psi (the sum of the frictional loss plus the elevation pressure loss). Therefore, a standard inlet pressure of 65 psi should more than suffice to overcome frictional and elevation pressure losses in any elevation changes across prime farm land and 500 feet in length.

The next design criterion to consider is the size of the inlet 42 and outlets 48,49 of the connection chamber 41. Using the 1.5-in.-diameter feed supply line 43 as above to provide a minimal flow rate typical of most membrane applications, the diameter of the inlet to the connection chamber 41 should be significantly smaller. Using a fourth-power dependency approximation equation, a diameter of 1/16th in. (0.0625 in.) will result in a flow rate of 3×10-6 of the original flow rate. In this case the original flow rate of 32 gallons per minute would result in 9.6×10-5 gallons per minute. This diameter can be adjusted for any desired flow rate. A critical factor is that the summation of all the desired flow rates into the connection chamber 41 cannot exceed the initial flow rate of the feed supply line 43.

It can be beneficial if the outlet line of the connection chamber 41 is larger than the inlet 42. Calculating exit velocities can help one designate the proper pressure control valve to be utilized.

### Example 2

In FIG. 4 a rolling hill is illustrated as an example of a downhill application of a system 60 where along the line a decrease in elevation is followed by an increase in elevation. This is an example of how the invention may be applied to an irrigation or fertilization system. A reservoir tank 61 is used as a means of maintaining a supply of water and/or fertilizer. This reservoir tank could be replaced by a fluid supply line, for example.

Water is pumped via a feed pump 62 (or gravity fed if the pump is to be omitted) into the feed supply line of the embodiment 60. While not intended to be a limitation of the invention, the system 60 is buried as a subsurface line beneath the ground surface 64 following the contour of the land. One skilled in the art will recognize that this system 60 could also be used as a surface or elevated system.

At the end of the run, an additional fluid pump 65 is added to return the fluid to the storage tank 61, which can be placed anywhere within the system 60. Here the system 60 is shown as comprising a recirculation system. Again, a benefit of a recirculation system is that expensive additives can be used with minimal waste and runoff.

As above, for prime farmland a slope of 8 degrees is considered to be maximum. In this example, if the length of application 70 was 500 feet, the elevation change 71 would be 40 feet. As for Example 1, without the present system 60, pressure would increase approximately 17 psi along the span from elevation start 66 to elevation end 67, greatly affecting the discharge of the irrigation water and/or fertilizer. Again, fresh water is conserved, as discussed above.

Following a first low point in elevation 68, there is an increase in elevation to point 69. From point 68 to point 69, the pressure decreases at 0.433 psi per foot of elevation change. The head pressure at this point would change 2.165 lbs if the change in elevation from 68 to 69 were 5 feet (=0.433×5).

A significance of the system 60 can be illustrated when compared with a standard run of drip irrigation tubing along this same run. With the standard drip irrigation tube, there will be significantly more flow at points of higher pressure. Therefore the flows at point 68 exceed that at all points where the elevation is higher, including point 69. When trying to apply a uniform and conservative amount of irrigation and/or fertilizer, this change in flow causes the even distribution to be an impossibility. Here, the pressure in the collection chamber 61 is the same throughout the run, and thus even distribution and application is achieved. A preset pressure is maintained in the collection chamber 61 despite the pressure changes in the feed and discharge lines caused by elevation changes or frictional effects.

It will be appreciated by one skilled in the art, that maintenance of a substantially constant pressure across changing elevations is a difficult task. If not engineered for each specific topographical application, no prior system is known to exist for mass application. It can also be appreciated that typical topographical changes are three dimensional and not simply two dimensional.

One skilled in the art can appreciate how complex current approaches to solving the elevation pressure losses and gains can quickly become complex and multi-tiered. These two factors alone can significantly add cost to any project or application. The need to engineer a specific solution for each individual application also results in an unwillingness to undertake such projects, thereby further demonstrating the significance of the present invention.

A third important factor is the need for highly efficient irrigation practices. Current technologies in development and becoming commercially available are the utilization of membrane technologies to provide highly efficient means of irrigation. These membranes require reduced- and constant-pressurize fluids for even distribution and application.

It has been shown that through the addition of a sectioned connection chamber and appropriate connections, the effects of pressure changes due to elevation changes can be minimized. This enables the application of technology that would have been held back due to the requirement of constant pressure being applied across varying elevations.

It has also been shown that the current invention can easily be modified into a single structure to reduce the complexity and provide for easy installation and application. Any possible combination of the assembly from separate components into a single entity can easily be appreciated by one skilled in the art.

It has additionally been shown that the present invention can be modified to provide additional benefits, such as that a recirculation system is possible for gaining additional benefits when applied to distribution systems such as irrigation, fertilization, or insecticide. Here, the discharge line captures and returns the overflow, while maintaining the optimal pressure.

Additionally, it has been shown that the present invention has many applications beyond those listed here, such as with membranes, spray heads, and drip tubing. The benefit of having a constant pressure at multiple points ensures an even distribution, no matter what the means of distribution is. Every point of distribution along the line operates in a substantially similar fashion.

It has also been shown that with small engineering changes, components such as the pressure-regulating valve can be eliminated; however, the easy and mass construction is forfeited, since all hole and tubing dimensions must be calculated and the components precisely assembled.

What is claimed is:

1. An irrigation system comprising:
an infeed line having an inlet connectable to a pressurized source of fluid;
a connection chamber having an inlet in fluid communication with an outlet of the infeed line, the inlet having an internal diameter less than an internal diameter of the infeed line; and
a pressure-regulating valve in fluid communication with means for regulating pressure adjacent an outlet of the connection chamber, the connection chamber connectable in fluid communication with a discharge line, the pressure-regulating means comprising a pressure-relief valve having a predetermined hold-back pressure.

2. The irrigation system recited in claim 1, further comprising a connecting line having an inlet in fluid communication with the infeed line outlet and an outlet in fluid communication with the connection chamber inlet, and further having an internal diameter less than the infeed line internal diameter.

3. The irrigation system recited in claim 2, wherein the connecting line comprises a plurality of connecting lines, each having an inlet in fluid communication with a separate outlet in the infeed line and an outlet in fluid communication with a separate inlet of the connection chamber.

4. The irrigation system recited in claim 1, wherein the connection chamber comprises a plurality of connection chambers connected in series longitudinally and having interior chambers isolated from each other.

5. The irrigation system recited in claim 1, further comprising a suction means in fluid communication with the pressure-regulating valve for preventing a formation of a back pressure.

6. The irrigation system recited in claim 1, wherein the infeed line, the connection chamber, and the discharge line are formed as a unitary structure, the discharge line comprising a porous membrane in covering relation to at least a portion of the connection chamber, pores in the porous membrane comprising outlets of the discharge line.

7. The irrigation system recited in claim 1, wherein the pressurized source of fluid comprises a reservoir tank and a pump in fluid communication with the reservoir tank in fluid communication with an inlet of the infeed line.

8. The irrigation system recited in claim 7, wherein the pump comprises a first pump, and further comprising a second pump downstream of the first pump, for recirculating fluid to the reservoir tank.

9. An irrigation method comprising:
connecting an infeed line inlet to a pressurized source of fluid;
connecting an inlet of a connection chamber with an outlet of the infeed line, the inlet having an internal diameter less than an internal diameter of the infeed line;
positioning a pressure-regulating valve in fluid communication with an outlet of the connection chamber; and
regulating a pressure of fluid exiting the connection chamber with the use of a pressure-relief valve having a predetermined hold-back pressure.

10. The irrigation method recited in claim 9, further comprising connecting a connecting line inlet with the infeed line outlet and connecting a connecting line outlet with the connection chamber inlet, and an internal diameter of the connecting line less than the infeed line internal diameter.

11. The irrigation method recited in claim 10, wherein the connecting line comprises a plurality of connecting lines, each having an inlet in fluid communication with a separate outlet in the infeed line and an outlet in fluid communication with a separate inlet of the connection chamber.

12. The irrigation method recited in claim 9, wherein the connection chamber comprises a plurality of connection chambers connected in series and having interior chambers isolated from each other.

13. The irrigation method recited in claim 9, further comprising connecting a suction means downstream of the pressure-regulating valve, for preventing a formation of a back pressure.

14. The irrigation method recited in claim 9, wherein the infeed line, the connection chamber, and the discharge line are formed as a unitary structure, the discharge line comprising a porous membrane in covering relation to at least a portion of the connection chamber, pores in the porous membrane comprising outlets of the discharge line.

15. The irrigation method recited in claim 9, further comprising positioning the infeed line, the connection chamber, and the discharge line within a porous tubular membrane, pores in the porous membrane comprising outlets of the discharge line.

16. The irrigation method recited in claim 9, wherein the pressurized source of fluid comprises at least one of a reservoir tank and a pump, and further comprising pumping fluid from the at least one of the reservoir tank and the pump to an inlet of the infeed line.

17. The irrigation method recited in claim 16, further comprising pumping fluid downstream of the at least one of the reservoir tank and the pump and the connection chamber back to the reservoir tank, for recirculating fluid to the reservoir tank.
